(19) United States
(12) Patent Application Publication
(10) Pub. No.: US 2002/0051737 A1
(43) Pub. Date: May 2, 2002

(54) Sample ejection device

(76) Inventors: Olaf Sollböhmer, Hamburg (DE); Dirk Möller, Hamburg (DE); Michael Busch, Hamburg (DE)

Correspondence Address: DILLER, RAMIK & WIGHT, P.C., Merrion Square, Suite 101, 7345 McWhorter Place, Annandale, VA, 22003, US

(21) Appl. No.: 09/740,864

(22) Filed: Dec. 21, 2000

(30) Foreign Application Priority Data
Nov. 1, 2000 (DE) 200 18 628.0

(51) Int. Cl. B01L 3/02

(52) U.S. Cl. 422/100; 422/63; 422/67

(57) ABSTRACT

A sample ejection device for pipetting or dispensing very small quantities comprises a sample ejection head (10). The sample ejection head (10) is provided with a plurality of pipettes (12), a plurality of micropumps (46) for conveying very small quantities, and at least one storage container (24) connected with the pipettes (12). The sample ejection device further comprises a control unit (26) for controlling the sample ejection head (10) and a monitoring unit (28) for monitoring the sample ejection head (10). For facilitating exchange of storage containers (24) or pipettes (12) the sample ejection head (10) is exchangeable as a whole. It is thus not necessary to exchange individual storage containers (24) or individual pipettes (12) during a pipetting process. Exchange of the entire sample ejection head (10) can thus be effected considerably more quickly.

### BACKGROUND OF THE INVENTION

The present invention relates to a sample ejection device for pipetting and/or dispensing very small quantities of biological and/or chemical substances and to a sample ejection head provided on the sample ejection device.

Such ejection devices are for example employed for high-throughput screening in the fields of diagnostics and research in the field of pharmazeutical products. In the case of high-throughput screening titer plates comprising for example 1536 or 2080 wells are filled with sample fluids and subsequently examined with the aid of an optical measuring instrument. The very small quantities contained in the wells are normally smaller than 500 nl, in particular smaller than 50 nl, more preferably smaller than 5 nl. In particular quantities in the subnanoliter range are filled into the wells. For filling the wells the sample ejection device comprises at least one pipetting and/or dispensing means, for example pipettes or dispensers. For dispensing and, if necessary, taking up of fluids the pipetting and/or dispensing means is connected with a means for conveying very small quantities, for example a micropump. Such micropumps normally comprise piezoelectric elements such that droplets in a volume of a few nanoliters or subnanoliters may be produced by applying a voltage.

The pipetting and/or dispensing means is further connected with a storage container containing a test fluid or a system fluid. Sample ejection devices are normally provided with a control unit and, if necessary, a monitoring unit which control and monitor the pipetting and/or dispensing means and the means for conveying very small quantities. Further said units control and monitor for example a stage on which one or a plurality of carrier plate/plates having an array of sample wells and a cleaning station are located. In particular when very small quantities are dispensed by the pipettes or dispensers, the position of the pipettes or dispensers relative to the carrier plate is controlled and monitored.

During a conventional pipetting process sample fluids are aspirated from the wells of a first carrier plate into the pipettes. The pipettes have a passage therethrough, said passage having a volume and a dispensing end and a system end, said dispensing end having a passage tip opening. For intake of the sample fluids the pipettes are filled with a system fluid with the sample fluid being aspirated through its dispensing end into the pipette by applying a vacuum. After the intake process a sample or test fluid is thus located in and proximate to the dispensing end of the pipette and followed by a system fluid, the latter being located in and proximate to the system end. The use of a system fluid to fill parts of the pipettes is particularly advantageous since the test fluids are in most cases extremely expensive. Subsequently, the stage is moved such that the pipettes are arranged above the wells of a second carrier plate. The pipettes are moved in vertical direction and feed, in several steps, the sample fluids taken from the first carrier plate in very small quantities to the wells of the second carrier plate. For this purpose the pipettes are connected for example with micropumps which dispense very small quantities of aspirated test fluid to a plurality of wells.

In the next step the pipettes are cleaned. For this purpose the stage is moved such that the pipettes are arranged above a cleaning station. During the cleaning process a cleaning fluid flows through the pipettes. The system fluid may be used as cleaning fluid and may be contained in the storage container connected with the pipettes. For removal of cleaning fluid residues from the passage tip opening, the pipettes are dabbed on an absorptive fleece. The pipettes are also cleaned from outside.

Then the stage is moved such that the pipettes are arranged again above the corresponding wells of the first carrier plate.

Instead of the movements being carried out by a stage, all movements may be executed by the pipettes. However, normally a stage or any other suitable transport means is used for moving the carrier plates in a horizontal plane while the movement in vertical direction is carried out by the pipettes or dispensers.

Exchanging the system fluid requires removal of the tubes arranged between the storage container containing the system fluid and the individual pipettes to allow the storage container to be exchanged. The exchange of the storage container is thus time-consuming and cost-intensive. Further, during removal of the tubes from the pipettes or the storage container system fluid frequently gets in contact with the device. This may result in contamination of the carrier plates and thus in falsification of measuring results. Removal of the tubes is further disadvantageous in that impurities may enter the pipettes. This may lead to clogging of the extremely thin pipettes.

Further the pipettes must be frequently exchanged, for example as a function of the viscosity of the test fluid used. Moreover, an exchange of the pipettes as a function of the quantity to be pipetted is necessary. When the pipettes are exchanged, the connecting tubes must be removed from the pipettes so that contamination may occur. Further the exchange of pipettes is particulary time-consuming and expensive since each pipette must be indivdually adjusted. Adjustment of the pipettes is extremely difficult due to the small distances between the wells into which the pipettes dispense their test fluids.

If the pipetting and/or dispensing means is at least one dispenser, a test fluid is fed via the dispenser to the wells. The dispensers have a passage therethrough, said passage having a volume and a dispensing end and a system end, said dispensing end having a passage tip opening. In contrast to the pipettes which aspirate test fluid through the passage tip opening, the passage of the dispenser is filled with test fluid via the system end. For this purpose a test fluid is contained in the storage container which is connected with the dispenser at the system end. The dispenser may be provided with a micropump which feeds very small quantities of test fluid to the wells. When the storage container or the dispensers are exchanged, the problems described above may occur.

It is an object of the present invention to provide a sample ejection device which allows the storage container and/or the pipetting and/or dispensing means to be exchanged in a more rapid and simple way wherein in particular the danger of contamination is avoided.

### SUMMARY OF THE INVENTION

The sample ejection device according to the invention comprises a sample ejection head which can be exchanged as a whole. The sample ejection head comprises, according to the invention, at least one pipetting and/or dispensing means, at least a means for conveying very small quantities, and at least one storage container connected with the pipetting and/or dispensing means. These and possibly further parts of the sample ejection head are supported on a common holder. Said holder is exchangeably connected with a reception part of the sample ejection device. According to the invention the sample ejection head is thus always exchanged as a whole.

The pipetting and/or dispensing means is in particular one pipette or a plurality of pipettes or one dispenser or a plurality of dispensers. They are preferably connected with a micropump used as a means for conveying very small quantities. Preferably each individual pipette or each individual dispenser is connected with a micropump which forms a unit with the pipette or the dispenser.

Exchange of individual pipettes/dispensers or individual storage containers is not required in the sample ejection device according to the invention. If for example a new test fluid is to be filled in during a screening process, it is merely necessary to replace the entire sample ejection head by another sample ejection head which comprises for example a storage container containg the corresponding test fluid or other pipettes/dispensers. The sample ejection head to be replaced may thus be prepared while the dispensing or pipetting process is carried out with another sample ejection head. Exchange of pipettes/dispensers, removal of tubes and cleaning of the sample ejection head can thus be performed outside the sample ejection device. This offers the advantage that the sample ejection device is not contaminated by leaking system and/or test fluid. Clogging of the pipettes/dispensers is also avoided. Further the pipetting process is interrupted for a considerably shorter period when the sample ejection head is exchanged as a whole instead of exchange of individual components of the sample ejection head since exchange of a storage container and removing and attaching of tubes are not necessary.

Preferably the holder of the sample ejection head comprises a quick-acting closure. Said closure is for example an eccentric connected with a lever with the holder being pressed against the reception part and retained there. Further a clamping closure may for example be provided as quick-acting closure where a clamp connected with a lever is shifted for fastening or releasing the holder.

For fastening purposes the holder preferably comprises a groove or a projection interacting with a projection or groove provided on the reception part. Preferably the groove and the projection are of dovetail configuration. In this embodiment the sample ejection head can be attached along dovetailed guide rails to the reception part connected with the sample ejection device. Said guide rails can precisely define the position of the sample ejection head. In addition to the guide rails a quick-acting closure may be provided.

For precise definition of the position of the sample ejection head on the sample ejection device it is further possible to provide the holder with a plurality of attachment bolts or pipetting openings which interact with pipetting openings and attachment bolts respectively on the reception part. Preferably three bolts and three corresponding pipetting openings are provided. The bolts can be configured relatively to the openings such that at least one bolt together with the corresponding opening defines the horizontal position and another bolt defines the vertical position. The position of the sample ejection head relative to the the reception part of the sample ejection device is thus defined in a simple manner.

The present invention further relates to a sample ejection head comprising, as described above, at least one pipetting and/or dispensing means, at least one means for conveying very small quantities, and at least one storage container connected with the pipetting and/or dispensing means. The sample ejection head according to the invention is configured such that it comprises a common holder supporting in particular the pipettes/dispensers, micropumps and the storage container. The sample ejection head thus forms a unit which is exchangeable as a whole. For fastening purposes the sample ejection head may comprise, as described above, a quick-acting closure, a groove, a projection, attachment bolts or pipetting openings. The groove or projections are preferably of dovetail configuration.

In a preferred embodiment the sample ejection head and/or the reception part provided on the sample ejection device comprises an adjusting device. Said adjusting device serves for precise definition of the position of the sample ejection head. Since the position of the individual pipettes/dispensers in the sample ejection head is defined and remains unchanged when the sample ejection head is exchanged, adjustment of the sample ejection head as a whole is sufficient. Adjustment of the individual pipettes/dispensers can be omitted or serves only for fine adjustment. In this connection it is particularly advantageous that in the event of exchange of the entire sample ejection head no tubes must be removed from the individual pipettes/dispensers since the forces exerted during removal of tubes frequently lead to maladjustment of the pipettes/dispensers.

The storage container, which forms part of the sample ejection head, may be connected with a cooling and/or heating unit by means of which the test fluid may be kept for example at the temperature required for preserving the fluid.

The cooling and/or heating unit preferably also forms part of the sample ejection head.

In particular when the sample ejection head comprises a plurality of storage containers which must be kept at different temperatures, it is advantageous to provide the cooling and/or heating unit on the sample ejection head.

It is also possible to manufacture the holder of the sample ejection head from a heat-conducting material such that a cooling and/or heating unit can be provided in the sample ejection device. Cooling and/or heating of fluids contained in one storage container or a plurality of storage containers is then effected via the heat-conducting holder. For this purpose the storage containers are heat-conductingly connected with the holder. This embodiment is less expensive than provision of a cooling and/or heating unit on the sample ejection head. However, when the cooling and/or heating unit is provided in the sample ejection device it is not possible or extremely difficult to keep fluids contained in a plurality of storage containers at different temperatures. It would for exampe be feasible to insulate cooling units or storage containers and keep another storage container at a higher temperature via the holder.

Further the sample ejection head preferably comprises at least one controller connected with the micropumps for controlling said micropumps. In this embodiment, the controller, too, is exchanged when the sample ejection head is replaced as a whole. Electrical connections between the micropumps and the controller need therefore not be disconnected when the pipettes/dispensers are exchanged.

Further the sample ejection head may comprise a control box connected with the individual micropumps. The control box is provided with a unique plug for connecting the control box with a controller arranged in the sample ejection device. Thus removal of the sample ejection head only requires a unique plug to be unplugged from a control box. It is not necessary to disconnect individual electrical connections each leading to an individual micropump. Unplugging of a plug from a control box further offers the advantage that maladjustment of pipettes/dispensers is prevented since it is not necessary to unplug individual plugs from the micropumps directly arranged on the pipettes/dispensers. Preferably the control box controls four, in particular eight, and more preferably sixteen micropumps.

During pipetting of fluids it is further necessary to control the pressure of the system fluid by means of a pressure controller. For this purpose a corresponding pressure controller may for example be provided directly on the sample ejection head. As the system fluid is preferably also used for cleaning the pipettes, a storage container containing system fluid is preferably provided in the sample ejection device since at this location it is easier to arrange containers adapted to accommodate larger fluid quantities. For connecting said system fluid container in the sample ejection device with the pipettes a unique fluid coupling is provided on the sample ejection head. From the fluid coupling the system fluid is then fed via a plurality of tubes to the individual pipettes. For controlling individual pipettes a suitable circuit controlling the system fluid pressure can be provided in individual pipettes. In this embodiment merely a single fluid coupling needs be decoupled for detaching the sample ejection head. Said fluid coupling preferably comprises a corresponding valve such that leakage of system fluid is prevented.

The pressure controller provided for controlling the system fluid pressure generates a vacuum in the system fluid, which is required for the intake of a test or sample fluid such that a given quantity of test fluid is aspirated for pipetting purposes. Subsequently, the aspirated sample fluid is ejected with the aid of the micropumps with only a small quantity of the aspirated test fluid being ejected by the micropumps. The quantity of aspirated test fluid is thus fed via the micropumps to a plurality of wells or droplet by droplet to one well each. The total quantity to be supplied to a well can also be obtained by ejecting several droplets into one and the same well. This offers the advantage that the well is filled with a sufficient quantity of fluid even if a few droplets do not reach or do not completely reach the corresponding well. When the test fluid is almost completely ejected into the wells, the pipettes are cleaned by moving the pipettes over a cleaning station and washing them with the system fluid.

In addition to the storage container containing test fluid the sample ejection head may also include a reservoir for a cleaning fluid. This ensures that during exchange of the pipettes/dispensers the sample ejection device is not contaminated by cleaning fluid. It is thus prevented that cleaning fluid flows into the wells of the sample carrier thus falsifying the measuring result.

The sample ejection device and the sample ejection head according to the invention are in particular suited for use in biological and/or chemical processes and preferably in the sector of diagnostics and/or research in the field of pharmaceutical products.

### BRIEF DESCRIPTION OF THE DRAWINGS

Hereunder a preferred embodiment of the invention is explained in detail with reference to the drawings in which:

FIG. 1 shows a schematical view of the essential components of a sample ejection device, and

FIG. 2 shows a perspective schematical view of a sample ejection head according to the invention.

### DESCRIPTION OF THE PREFERRED EMBODIMENT

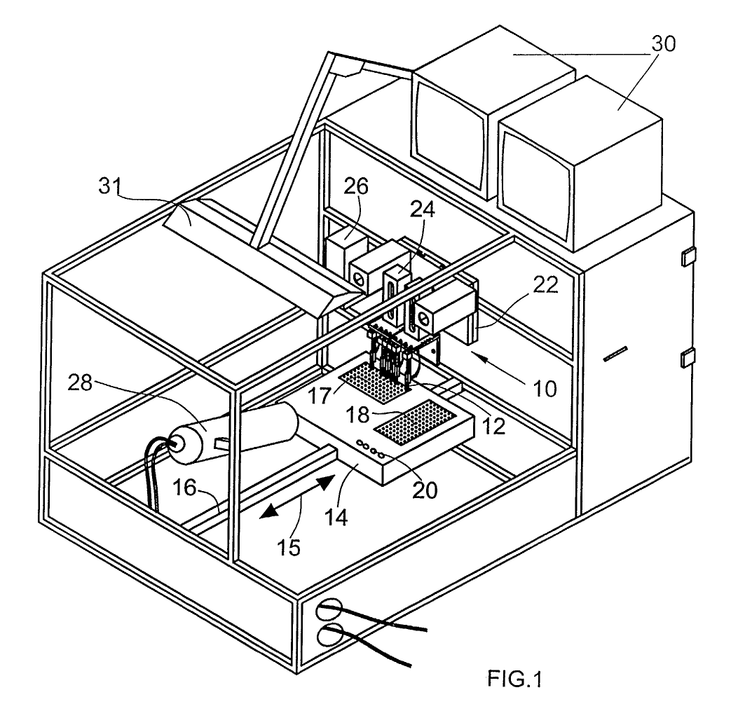

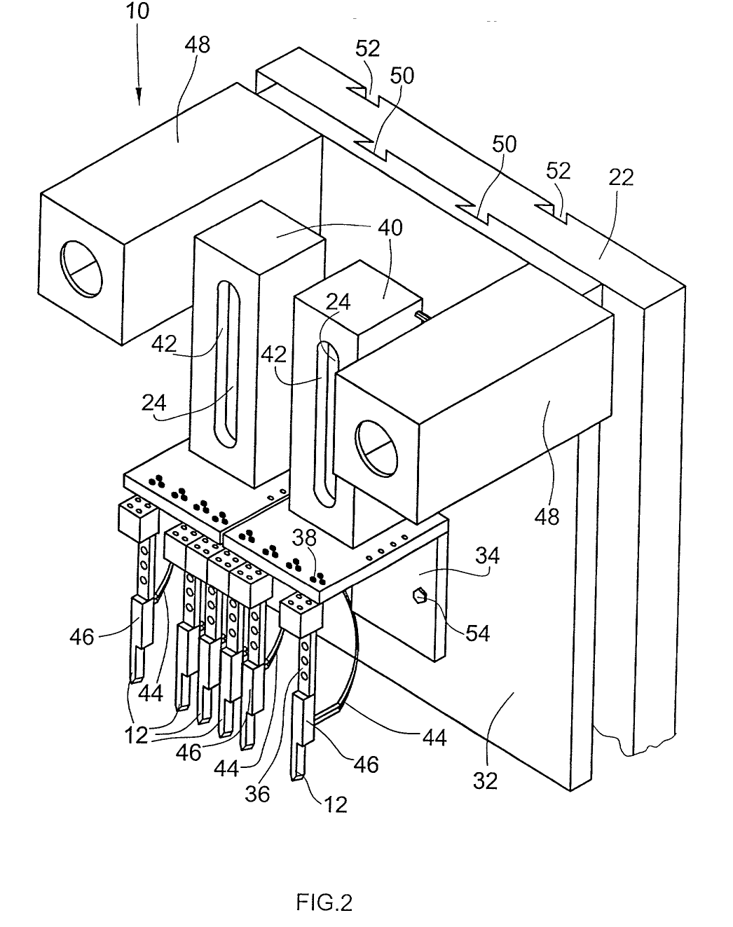

A sample ejection device comprises a sample ejection head 10 as the central component. In the embodiment shown in FIGS. 1 and 2 said sample ejection device is a pipetting device for pipetting fluids. Below the pipettes 12 of the sample ejection head 10 a stage 14 is arranged. The stage 14 can be shifted along a guide rail 16 in the direction indicated by the arrow 15. Further the stage 14 is adapted to pivot about a central axis.

On the stage 14 for example two carrier plates 17,18 are arranged. Further the stage 14 comprises a cleaning station 20.

The sample ejection head 10 is fastened via a reception part 22 to a frame of the sample ejection device. The entire sample ejection head 10, together with the reception part 22, can be moved in vertical direction. Owing to the vertical movement of the sample ejection head 10 the pipettes 12 are for example lowered into the wells of the carrier plates 17 or 18.

During a conventional pipetting process the pipettes 12 are, in a first step, lowered into the wells of the carrier plate 17 and take a sample fluid from said wells. This is effected for example by applying a vacuum to the pipettes 12. For taking in test or sample fluid the pipettes 12 contain system fluid to which a vacuum is applied. Then the stage 14 is shifted and pivoted such that the pipettes 12 are arranged above the wells of the carrier plate 18. The pipettes 12 are now lowered into the wells on the carrier plate 18 and eject, in several steps, the fluid taken from the wells of the carrier plate 17 into a plurality of well rows. The carrier plates 17,18 may be arranged on the stage 14 such that the stage 14 needs not be pivoted.

Then the entire sample ejection head 10, together with the pipettes 12, is moved upward in vertical direction such that there is a distance between the tips of the pipettes 12 and the carrier plate 18. Now the stage 14 is shifted in the direction indicated by the arrow 15 such that the pipettes 12 are arranged above the cleaning station 20. In this position cleaning fluid flows through the pipettes 12 into the drip container of the cleaning station 20. To prevent cleaning fluid droplets from adhering to the tip of the pipettes 12 the sample ejection head 10 is moved downward in vertical direction until the tip of the pipettes 12 touch a dabbing fleece or similar which absorbs the cleaning fluid.

In the next step the stage 14 is shifted such that the pipettes 12 are again arranged above the previously filled wells of the carrier plate 18. In the following step the sample ejection head 10 is lowered again and test fluid is fed from the storage containers 24 connected with the pipettes 12 to the corresponding wells.

Thereafter the pipettes 12 are cleaned again so that a pipetting process is completed. The pipetting illustrated above is a typical pipetting process. However with the aid of the sample ejection device described above other pipetting processes can be carried out in various process steps. The idea of the invention is that a sample ejection head 10 is provided which can be exchanged as a whole. This aspect is independent of the pipetting process carried out by means of the sample ejection device.

The sample ejection device further comprises a control unit 26 for controlling the sample ejection head 10. The control unit 26 controls, inter alia, the vertical movement of the sample ejection head 10 and the valves provided in the sample ejection head 10. Further the movement of the stage 14 can be controlled by the control unit 26 or another control unit.

For exact determination of the position of the pipettes 12 relative to the wells of the carrier plates 17,18 the sample ejection device further comprises a monitoring unit 28 which in the embodiment described is a video monitoring unit. It is also possible to provide sensors for position monitoring purposes.

The sample ejection device further comprises monitors 30. Via the monitors 30 for example the sequence of operations of the pipetting process can be monitored. Further the picture taken by a camera 28 can be displayed to check whether the pipetting processes have been carried out without any troubles.

Further the sample ejection device comprises an illumination unit 31.

The sample ejection head 10 (FIG. 2) is provided with a holder 32 which is of plate-type configuration in the embodiment described. An L-shaped reception device 34 is fastened to the holder 32. The reception device 34 supports the pipettes 12. The pipettes 12 are connected with the L-shaped reception device 34 via a a web 36. With the aid of screws 38 each individual pipette 12 can be adjusted relatively to the holder 32.

The holder 32 further serves for receiving the storage containers 24. In the illustrated embodiment of the pipetting head the storage containers 24 are filled with system fluid. If the sample ejection head 10 is a device for dispensing fluid, the storage container 24 is filled with a test fluid. The test fluid is supplied via dispensers 12 to the wells. For dispensing very small quantities of test fluid micropumps 46 are used which are arranged in the dispensers 12. For controlling the temperature of the test fluid the storage containers 24 are surrounded by a metal housing connected with a cooling and/or heating unit which is not shown in the drawings. The housing 40 comprises a slot-type viewing port 42 through which the quantity of fluid contained in the storage containers 24 can be read. The storage containers 24 may be provided with an optical level sensor.

For supplying the pipettes 12 with system fluid the storage containers 24 are connected via tubes 44 with the pipettes 12. During pipetting of sample fluid from a first titer plate 17 (FIG. 1) onto a second titer plate 18 a vacuum is applied to the system fluid such that the pipettes 12 aspirate sample fluid from the titer plate 17. Subsequently, the aspirated sample fluid is ejected in several steps to a plurality of well rows of the carrier plate 18. For this purpose the micropumps 46 are activated accordingly.

For controlling the micropumps 46 controllers 48 are provided. The controller 48 for the micropumps 46 also form part of the sample ejection head 10. The controller 48 for the micropumps 46 are permanently attached to the holder 32 of the sample ejection head 10. For controlling the micropumps 46 said pumps 46 are connected via electrical lines, which are not shown in the drawings, with the pressure controllers 48. The controller 48 for the micropumps 46 may be connected via further lines with the control unit 26 (FIG. 1).

To allow for easy exchange of the sample ejection head 10 the holder 32 comprises dovetailed grooves 50. In the illustrated embodiment said grooves 50 extend in vertical direction over the entire rear side of the plate-type holder 32 facing the reception part 22. Said reception part 22 is provided with corresponding dovetailed projections or guide rails.

The reception part 22 comprises dovetailed grooves 52 on the side facing the sample ejection device. With the aid of the dovetailed grooves 52 the reception part 22 can be shifted in vertical direction. By shifting the reception part 22 in vertical direction the sample ejection head 10 attached to the reception part 22 is also shifted in vertical direction.

For exchanging the sample ejection head 10 the head 10 needs merely be removed from the projections in vertical direction. The new sample ejection head 10 can then be attached in vertical direction onto the projections of the reception part 22. The reception part 22 comprises a stop element such that the sample ejection head 10 is retained in a defined horizontal position.

In addition to the dovetailed groove 50 and the dovetailed projections on the reception part 22 a quick-acting closure, for example in the form of a clamping lever with eccentric, may be provided. The quick-acting closure provides a permanent connection between the holder 32 and the reception part 22. The entire sample ejection head 10 is thus permanently attached to the reception part 22 in a simple manner.

The sample ejection head 10 shown in FIG. 2 is a double head configuration. Each of the two heads comprises a metal housing 40 accommodating a storage container 24. Further each of the two sample ejection heads is provided with a reception device 34 which supports, in addition to the storage container 24, the pipettes 12 plus micropumps 46. The two sample ejection heads are connected via bolts 54 and, if necessary, via a quick-acting closure with the holder 32 and are easily removable from the latter.

For vertical movement of the sample ejection head 10 the reception part 22 is moved up and down on guide rails, which are not shown in the drawings, meshing in the grooves 52. Provision of a reception part on the sample ejection device for receiving the sample ejection head 10 offers the advantage that the vertical movement of the sample ejection head 10 is effected by movement of the reception part 22. Activation units and the connection between the activation units and the reception part 22 thus remain on the sample ejection device when the sample ejection head 10 is exchanged. This facilitates exchange of the sample ejection head 10.

Although a preferred embodiment of the invention has been specifically illustrated and described herein, it is to be understood that minor variations may be made in the device without departing from the spirit and scope of the invention, as defined in the appended claims.

What is claimed is:

1. Sample ejection device for pipetting and/or dispensing very small quantities of biological and/or chemical substances, the device comprising:
at least one pipetting and/or dispensing means (12),
at least one storage container (24) connected with the pipetting and/or dispensing means (12),
at least one means (46) for conveying very small quantities, and
a control unit (26),
wherein a sample ejection head (10) is provided which comprises the pipetting and/or dispensing means (12), the means (46) for conveying very small quantities, and the storage container (24) as well as a holder (32) which is, together with the parts (12,24,46) attached thereto, exchangeably fastened to a reception part (22).

2. Sample ejection device according to claim 1, wherein the holder (32) comprises a plurality of attachment bolts or pipetting openings for fastening purposes and the reception part (22) comprises a plurality of pipetting openings or attachment bolts respectively.

3. Sample ejection device according to claim 1, wherein the holder (32) comprises a groove (50) or a projection for fastening purposes and the reception part (22) comprises a projection or a groove (52) respectively.

4. Sample ejection device according to claim 3, wherein the projection and the groove (50) are of dovetail configuration.

5. Sample ejection head comprising at least one pipetting and/or dispensing means (12), at least one means (46) for conveying very small quantities, and at least one storage container (24) connected with the pipetting and/or dispensing means (12), wherein a common holder (32) supporting the pipetting and/or dispensing means (12), the means (46) for conveying very small quantities and the storage container (24) is provided, the holder (32), together with the parts (12,24,46) attached thereto, being exchangeable as a whole.

6. Sample ejection head according to claim 5, wherein the holder (32) comprises a plurality of attachment bolts or pipetting openings for fastening purposes.

7. Sample ejection head according to claim 5, wherein the holder (32) comprises a groove (50) or a projection for fastening purposes.

8. Sample ejection head according to claim 7, wherein the projection and the groove (50) are of dovetail configuration.

9. Sample ejection device according to claim 1 or sample ejection head according to claim 5, wherein the sample ejection head (10) and/or the reception part (22) comprise an adjusting means.

10. Sample ejection device according to claim 1 or sample ejection head according to claim 5, wherein the sample ejection head (10) comprises a cooling and/or heating unit connected with the storage container (24).

11. Sample ejection device according to claim 1 or sample ejection head according to claim 5, wherein the sample ejection head (10) comprises at least one controller (48) connected with the means (46) for conveying very small quantities.

12. Sample ejection device according to claim 1 or sample ejection head according to claim 5, wherein the sample ejection head (10) comprises a cleaning fluid reservoir connected with the at least one pipetting and/or dispensing means (12).

13. Sample ejection device according to claim 1 or sample ejection head according to claim 5, wherein the storage container (24) is exchangeable.

14. Sample ejection device according to claim 1 or sample ejection head according to claim 5, wherein a level sensor is associated with the storage container (24).

15. Sample ejection device according to claim 1 or sample ejection head according to claim 5, wherein the sample ejection device comprises a cooling and/or heating unit and the temperature of the storage container (24) is controlled via the holder (32).

16. Sample ejection device according to claim 1 or sample ejection head according to claim 5, wherein at least two, preferably four, more preferably eight and in particular sixteen pipetting and/or dispensing means (12) are arranged on a sample ejection head (10).

17. Sample ejection device according to claim 1 or sample ejection head according to claim 5, wherein the very small quantities are smaller than 500 nl, preferably smaller than 50 nl, more preferably smaller than 5 nl and lie in particular in the subnanoliter range.

18. Sample ejection device according to claim 1 or sample ejection head according to claim 5, wherein the means (46) for conveying very small quantities forms part of the pipetting and/or dispensing means (12).
